(19) United States
(12) Patent Application Publication
(10) Pub. No.: US 2007/0255641 A1
(43) Pub. Date: Nov. 1, 2007

(54) Computer interface for trading bonds

(76) Inventors: Kevin F. Harrington, Huntington, NY (US); Kenneth Torres, Ossining, NY (US); James F. Wheeler, Yardley, PA (US)

Correspondence Address: TORYS LLP, 79 WELLINGTON ST. WEST, SUITE 3000, TORONTO, ON, M5K 1N2, CA

(21) Appl. No.: 11/412,789

(22) Filed: Apr. 28, 2006

(51) Int. Cl. G06Q 40/00

(52) U.S. Cl. 705/37

(57) ABSTRACT

The present invention provides a novel computer interface for trading municipal bonds. Aspects of the invention include a trading engine hosted by a broker's broker and which is accessed by a number of brokers (or the like) via client-machine that are networked to the trading engine. The interface allows the broker to provide search criteria for municipal bonds that may be available as offerings or as bid-wanteds. The interface can also allow the same broker to provide requests for bids for municipal bonds, so that the broker's broker can conduct a bid-wanted process. Each time the search information is updated, a notification is pushed to the broker's client-machine. Likewise, when the bids responsive to the bid-wanted process have been aggregated by the broker's broker, a notification is pushed to the broker's client-machine. This permits the broker to have information that allows the broker to prioritize the order in which the information respective to each notification should be treated, thereby increasing the efficiency of the broker.

### FIELD OF THE INVENTION

The present invention relates to electronic trading and more particularly relates to a computer interface for trading bonds. The invention also relates to systems and methods that provide such a computer interface and that enable the provision of that interface.

### BACKGROUND OF THE INVENTION

Electronic trading is commonly employed for trading a wide range of transferable interests that represent financial value. Electronic trading is now ubiquitous and in many circumstances the preferred means for the trading of bonds, stocks, future options, and other securities. Electronic trading systems are becoming increasingly complex, offering a wide range of options and tools for all parties involved in trading. The art, however, is still evolving at a rapid pace.

Each type of security has its own unique characteristics and rules governing those securities, often requiring specific trading systems for each type of security. Municipal bonds are an example of a security that has unique characteristics that must be considered in an electronic trading system for municipal bonds. Municipal bond trading systems thus present their own unique problems to be overcome in order to provide an effective system that properly serves the bond market. Known municipal bond trading systems include the systems hosted by Chapdelaine & Co., One Seaport Plaza 17th Floor New York, N.Y. 10038 (http://www.chappy.com) and The MuniCenter, 540 Madison Ave, 4th Floor, New York, N.Y. 10022 (http://www.themunicenter.com). A number of other municipal bond trading systems are also known.

One unique characteristic to municipal bonds is that they have, historically, not been traded on a formal exchange, but instead traded through a network of brokers (or the like, such as a broker/dealer, dealer, or dealer bank), who in turn make use of a broker's broker. The broker's broker provides a marketplace, much like an exchange, where brokers can buy and/or sell municipal bonds. In fact, during a given trading day, brokers often simultaneously buy municipal bonds on behalf of a number of investors and sell municipal bonds on behalf of a number of other investors. Likewise, the broker's broker also simultaneously buys municipal bonds on behalf of a number of brokers and sells municipal bonds on behalf of a number of other brokers.

In order to attract business from investors, it is important that a broker offers investors the ability to find the best price for their municipal bond and fulfill orders at that price in a timely fashion. In order to attract business from brokers, it is likewise important that a broker's broker offers brokers a municipal bond trading system that allows the broker to serve its investors efficiently and effectively. It is thus important that municipal bond trading systems have computer interfaces that are feature rich and have a high-degree of usability for the broker. In order to be competitive the broker's broker must provide value-added service in a timely manner.

Features and usability of computer interfaces for municipal bond trading systems have only advanced so far. Municipal bond trading systems currently allow brokers to post information on behalf of their selling investors while also allowing those same brokers to browse posted-information on behalf of their buying investors. Municipal bond trading systems also allow brokers to fulfill orders by acting on the information hosted by the system. A significant problem with existing computer interfaces is that the broker needs to utilize his own initiative and skill to track disparate information that is relevant to a plurality of different investors. This limits the number of investors for which the broker can act in an efficient and/or effective manner. Moreover, this limits the speed with which the broker can act. Telephone intervention by the broker's broker is often needed to ensure that the broker is taking timely action based on changing information.

As an example, assume that one broker using a prior art municipal bond trading system is acting on behalf of ten different buying investors and ten different selling investors in a given day. (Those of skill in the art will recognize that it is not uncommon for one broker to act on behalf of far more than twenty investors in a single day.) The broker will thus need to search for ten different sets of buying information in order to locate municipal bonds that meet the needs of each buying investor. If the search criteria are not satisfied, the broker will need to periodically refresh each search. At the same time the broker will need to periodically check for responses to information that was posted on behalf of its selling investors. As the broker continues to act for more and more investors, it becomes increasingly difficult for the broker to serve all of the investors in a timely and efficient fashion. Further enhancements to computer interfaces for trading of municipal bonds, and underlying municipal bond trading system, are needed.

The prior art does not address these needs. Such prior art relates to fields that are generally unrelated and inapplicable to municipal bond trading. U.S. Pat. No. 5,995,947 to Fraser, et al. issued Nov. 30, 1999 discloses a method and system for trading loans in real time by making loan applications, such as home mortgage loan applications, and placing them up for bid by a plurality of potential lenders. A transaction server maintains a database of pending loan applications and their statuses; each party to the loan can search and modify that database consistent with their role in the transaction, by requests to the server from a client-machine identified with their role. Brokers at a broker station can add loan applications, can review the status of loan applications entered by that broker, are notified of lender's bids on their loans, and can accept bids by lenders. Lenders at a lender station can search the database for particular desired types of loans, can sort selected loans by particular desired criteria, can bid on loan applications, and are notified when their bids are accepted. For the lender only, U.S. Pat. No. 5,995,947 contemplates a search facility which can be made into an “active” search where the lender can be notified of revised results of a loan profile search. U.S. Pat. No. 5,995,947 is not applicable or useful in a municipal bond trading system as municipal bonds have regulatory and other characteristics that are materially different from loan applications. Of particular note, in a loan application environment, the lender and broker maintain separate and unique roles, whereas in the municipal bond trading environment each broker typically holds a dual role—acting on behalf of a multiplicity of both buying and selling investors. Therefore, U.S. Pat. No. 5,995,947 does not address the unique needs of a municipal bond broker. Also of note is that in a municipal bond trading system a broker's broker also oversees the interactions between the brokers, and U.S. Pat. No. 5,995,947 does not address this unique role of the broker's broker. U.S. Pat. No. 6,772,146 to Khemlani, et al. issued Aug. 3, 2004 has similar limitations as U.S. Pat. No. 5,995,947, in that it is only directed to the needs of a single role of a retail investor (and the like) seeking to purchase a security, and not the dual role of the municipal bond broker.

U.S. Pat. No. 5,974,406 to Bisdikian, et al. issued Oct. 26, 1999 discloses a method and apparatus for providing notification in response to a search query. The query can be received from a user via a user interface. The user selects a time and means of notification, such as for example, by fax at a specified time. The system will also receive several notification choices from both the user and a supplier of information and match the choices so that a supplier can notify a user in accordance with a mutually selected time and means of notification. U.S. Pat. No. 5,974,406 is not applicable or useful in a municipal bond trading system as the notification occurs only after the user has logged off.

U.S. Pat. No. 6,594,682 to Peterson, et al. issued Jul. 15, 2003 discloses a client-machine-based system with a scheduling subsystem to schedule a time to obtain the Web content from the server. When the client-machine reaches the scheduled time, the scheduling subsystem generates an event notification that contains sufficient information explaining how to retrieve the Web content. U.S. Pat. No. 5,974,406 is not applicable or useful in a municipal bond trading system as the scheduling for retrieving the Web content occurs on the client-machine side, which means that changes on the server-side may have occurred that would be missed on the client-machine side.

US20040162772 to Lewis, Charles J. and published Aug. 19, 2004 “Financial data reporting system with alert notification feature and free-form searching capability” discloses an integrated financial data reporting system that provides for real time data entry, assessment, and report generation. The system includes message formatting, database management, and select applications for preparing sophisticated financial presentations in essentially real time. An alert notification server alerts users when a financial threshold specifying a credit limit and/or a trading limit has been crossed. A data distribution server electronically distributes data to users on a recurring and/or periodic basis, and a search engine server provides free-form searches against information stored in a consolidated database. US20040162772 does not however, improve a broker's efficiency in simultaneously acting on behalf of a number of municipal bond investors before a single municipal bond trading system.

### SUMMARY OF THE INVENTION

It is an object of the present invention to provide a novel computer interface for electronic trading that obviates or mitigates at least one of the above-identified disadvantages of the prior art.

An aspect of the invention provides a method of controlling a computer interface for trading municipal bonds comprising:
receiving, at a municipal bond trading engine from a broker's client-machine connected to the trading engine, a plurality of search requests for available municipal bonds for purchase on behalf of one or more buying investors;
receiving, at the municipal bond trading engine from the broker's client-machine connected to the trading engine, a plurality of bid-wanted requests seeking bids for a plurality of municipal bonds for sale using a bid-wanted process on behalf of one or more selling investors;
performing and repeating, at the municipal bond trading engine, searches in accordance with the search requests;
pushing a search-update notification to the broker's client-machine each time any one of the searches change;
performing, at the municipal bond trading engine, a bid-wanted process in accordance with the bid-wanted request; the bid-wanted process including posting the bid-wanted, receiving bids responsive to the bid-wanted and aggregating the bids into a list; and,
pushing a bid-list ready notification to the broker's client-machine indicating that the list is ready for viewing by the broker.

The method can further comprise the step of performing respective further follow-up searches and repeating the step of pushing a search-update notification to the broker's client-machine each time any one of the searches changes until a command terminating one or more of the search requests is received from the broker's client-machine at the municipal bond trading engine.

In the method, one or both of the notifications can comprise at least one of an auditory and a visual signal presented at the broker's client-machine.

The method can further comprise the step of pushing results of the follow-up search to the broker's client-machine.

The method can further comprise the step of pushing results of the follow-up search to the broker's client-machine based on input from the client-machine received at the trading engine requesting same.

The method can further comprise the step of presenting the search-update notification and the bid-list ready notification on the broker's client-machine at substantially the same time.

The method can further comprise the step of pushing the list to the selling broker's client-machine.

Another aspect of the invention provides a municipal bond server for hosting trading municipal bonds by a broker's broker comprising an interface for connecting via a network to a first broker's client-machine and a plurality of additional broker's client-machines. The server also comprises a processor interconnecting the interface via a bus with persistent storage and non-persistent storage. The processor is configured to perform a plurality of programming instructions which configure the processor to operate as a municipal bond trading engine. The trading engine is operable to receive, via the interface, from the first broker's client-machine, a plurality of search requests for available municipal bonds for purchase on behalf of a plurality of buying investors. The trading engine is further operable to receive, via the interface, from the first broker's client-machine, a plurality of bid-wanted requests seeking bids for a plurality of municipal bonds for sale using a bid-wanted process on behalf of at least one selling investor. The trading engine is further operable to perform and repeat searches in accordance with the search requests, and to push a search-update notification to the first broker's client-machine each time any one of the searches changes. The trading engine is further operable to perform a bid-wanted process in accordance with the bid-wanted request. The bid-wanted process includes posting the bid-wanted to at least some of the plurality of additional broker's client-machines, and receiving bids responsive to the bid-wanted and aggregating the bids into a list. The trading engine is further operable to push a bid-list ready notification to the broker's client-machine indicating that the list is ready for viewing by the broker.

The trading engine can be further operable to perform respective further follow-up searches and repeat pushing of a search-update notification to the broker's client-machine each time any one of the searches changes, until a command terminating one or more of the search requests is received from the first broker's client-machine.

One or both of the notifications can comprise at least one of an auditory and a visual signal presented at the broker's client-machine.

The trading engine can be further operable to push results of the searches to the first broker's client-machine.

The trading engine can be further operable to push results of the follow-up search to the broker's client-machine based on input from the client-machine received at the trading engine requesting same.

The trading engine can be further operable to present the search-update notification and the bid-list ready notification on the broker's client-machine at substantially the same time.

The trading engine can be further operable to push the list to the selling broker's client-machine.

Another aspect of the invention provides a municipal bond broker's client-machine operated by a broker for interacting with a municipal bond server hosting trading of municipal bonds by a broker's broker comprising an interface for connecting via a network to the municipal bond server. The client-machine also comprises a processor interconnecting the interface via a bus with persistent storage (e.g. a hard disk drive and/or read only memory), non-persistent storage (e.g. random access memory), an input device and a display device. The processor is configured to receive, via the input device, a search request for available municipal bonds for purchase on behalf of a buying investor. The processor is also operable to forward the search request to the municipal bond server via the interface. The processor is further operable to receive, via the input device, a plurality of bid-wanted requests seeking bids for a plurality of municipal bonds for sale using a bid-wanted process on behalf of at least one selling investor. The processor is further operable to forward the bid-wanted requests to the municipal bond server. The processor is further operable to receive, via the interface, a search update-notification from the municipal bond server. The search-update notification represents that one or more searches performed in accordance with the search requests by the municipal bond server has changed. The processor is further operable to present the search-update notification on the display device. The processor is also operable to receive, via the interface, a bid-list ready notification from the municipal bond server. The bid-list notification represents that a list of bids prepared according to the bid-wanted process is ready for viewing. The processor is also operable to present the search bid-list notification on the display device.

Another aspect of the invention provides a method of controlling a computer interface for trading municipal bonds comprising:
receiving, at a municipal bond trading engine hosted by a municipal bond broker's broker, a search request from a broker's client-machine for at least one of offerings of municipal bonds and bid-wanteds of municipal bonds;
performing an initial search of municipal bonds using search criteria associated with the search request at the municipal bond trading engine;
pushing the search results to the broker's client-machine;
performing at least one follow-up search that is substantially the same as the initial search until results of the at least one follow-up search is different then the initial search; and,
pushing a notification that the at least one follow-up search is different to the broker's client-machine.

The method can further comprise the step of:
performing further follow-up searches and repeating the final two steps of the aforementioned method until a command terminating the search request is received.

The notification can be at least one of an auditory and a visual signal presented at the broker's client-machine.

The method can further comprise the step of pushing results of the follow-up search to the broker's client-machine.

The method can further comprise the step of pushing results of the follow-up search to the broker's client-machine based on input from the client-machine received at the trading engine requesting same.

Another aspect of the invention provides a method of controlling a computer interface for trading municipal bonds comprising:
receiving, at a municipal bond trading engine hosted by a municipal bond broker's broker, a request from a selling broker via a selling broker's client-machine for a bid-wanted that is respective to a municipal bond;
posting the request to a plurality of potential buying broker's;
receiving bids respective to the request from at least a portion of the potential buying broker's;
aggregating the bids into a list for presentation to the selling broker;
pushing a notification to the selling broker's client-machine that the list is ready for viewing by the selling broker.

The method can further comprise the step of pushing the list to the selling broker's client-machine.

The notification can be at least one of an auditory and a visual signal presented at the broker's client-machine.

### BRIEF DESCRIPTION OF THE DRAWINGS

The invention will now be described by way of example only, and with reference to the accompanying drawings, in which:

FIG. 1 is a schematic representation of a municipal bond trading system;

FIG. 2 is a flow-chart of a method for controlling a trading interface in accordance with an embodiment of the invention;

FIGS. 3A and 3B (hereinafter referred to collectively as FIG. 3) are exemplary screen shots that can be generated on an interface of a broker's client-machine when performing certain steps of the method of FIG. 2 on the system of FIG. 1;

FIGS. 4A and 4B (hereinafter referred to collectively as FIG. 4) are exemplary screen shots that can be generated on an interface of a broker's client-machine when performing certain steps of the method of FIG. 2 on the system of FIG. 1;

FIGS. 5A and 5B (hereinafter referred to collectively as FIG. 5) are exemplary screen shots that can be generated on an interface of a broker's client-machine when performing certain steps of the method of FIG. 2 on the system of FIG. 1;

FIGS. 6A and 6B (hereinafter referred to collectively as FIG. 6) are exemplary screen shots that can be generated on an interface of a broker's client-machine when performing certain steps of the method of FIG. 2 on the system of FIG. 1;

FIGS. 7A and 7B (hereinafter referred to collectively as FIG. 7) are exemplary screen shots that can be generated on an interface of a broker's client-machine when performing certain steps of the method of FIG. 2 on the system of FIG. 1;

FIG. 8 is a flow-chart of a method for controlling a trading interface in accordance with an embodiment of the invention;

FIGS. 9A and 9B (hereinafter referred to collectively as FIG. 9) are exemplary screen shots that can be generated on an interface of a broker's client-machine when performing certain steps of the method of FIG. 8 on the system of FIG. 1; and,

FIGS. 10A and 10B (hereinafter referred to collectively as FIG. 10) are exemplary screen shots that can be generated on an interface of a broker's client-machine when performing certain steps of the method of FIG. 8 on the system of FIG. 1.

### DETAILED DESCRIPTION OF THE INVENTION

The following definitions are used herein.
Bid-wanted. A bid-wanted is a notice to potential buying brokers that a particular municipal bond may come for sale if the bid price received is acceptable to the selling broker acting on behalf of the selling investor. A bid-wanted has no advertised price attached to the municipal bond. The lack of an advertised price represents a significant distinguishing features of a bid-wanted from a traditional posted offering. For further information on bid-wanteds, see also, for example, U.S. patent application Ser. No. 10/346,222, filed Jan. 15, 2003 and entitled “Interactive Security Brokerage System”, incorporated herein by reference.
Buying Broker. Within the specific context where the term is used, a broker that is acting on behalf of a particular buying investor.
Broker. A party that acts on behalf of one or more investors. A single broker may simultaneously act on behalf of a number of buying investors and selling investors. The present teachings contemplate that a broker and an investor can be the same party, in which case the broker is (as is well understood by those skilled in the art) a dealer. The term broker as used herein can thus refer to a broker, a dealer, a broker/dealer or a dealer-bank. Typically each broker works for a firm that employs several individual brokers. The single term broker is used for convenience, to simplify explanation of the embodiments herein, but the term broker is used in a non-limiting sense.
Broker/Dealer. See Broker.
Broker's broker. An individual employed by a broker's brokerage firm that interacts with individual brokers. In certain contexts, the use of the term
“broker's broker” may refer to broker's brokerage firm. Broker's brokerage firm. A firm that acts on behalf of a broker. Such a firm does not underwrite new issues, carry inventory positions, or deal with public customers.
Buying investor. An investor that wishes to purchase municipal bonds.
Client-machine. A computing device used to access a server.
CUSIP. A unique identification number assigned to each particular municipal bond by the Committee on Uniform Security Identification Procedures.
Dealer. See Broker.
Dealer-bank. See Broker.
Investor. An individual, corporation or a legal entity that maintains an inventory of municipal bonds, or intends to maintain an inventory of municipal bonds.
Selling Broker. Within the specific context of where the term is used, a broker that is acting on behalf of a particular selling investor.
Selling investor. An investor with an existing inventory of municipal bonds who wishes to sell those municipal bonds
Server. A computing device that hosts one or more applications for a client-machine.

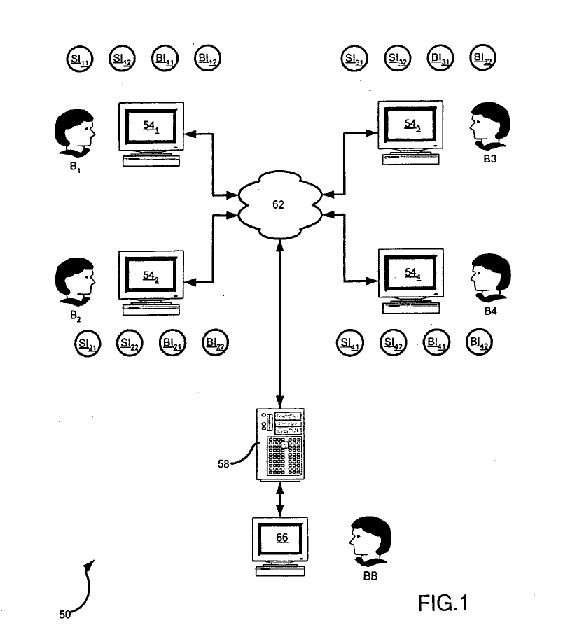

Referring now to FIG. 1, a municipal bond trading system is indicated generally at 50. System 50 comprises a plurality of broker client-machines 54 intermediately connected to a broker's broker server 58 via a network 62. In FIG. 1, individual broker client-machines 54 are specifically identified as broker client-machine 54₁, 54₂, 54₃, 54₃. System 50 also comprises a broker's broker client-machine 66 that is locally connected to server 58.

Each client-machine 54 is typically a computing device such as a personal computer having a keyboard and mouse (or other input devices), a monitor (or other output devices) and a desktop-module connecting the keyboard, mouse and monitor. The desktop-module houses one or more central processing units, volatile memory (for example, random access memory), persistent memory (for example, hard disk devices) and network interfaces to allow client-machine 54 to connect to server 58 via network 62. However, it is to be understood that in other embodiments client-machine 54 can be any type of computing device, such as a personal digital assistant, cell phone, laptop computer, email paging device etc.

Each client-machine 54 is operated by a broker B acting on behalf of one or more selling investors SI that wish to sell municipal bonds from their inventory and/or one or more buying investors BI that wish to acquire municipal bonds for their inventory. Since system 50 is web-based, each client-machine 54 is operable to execute a web-browser. FIG. 1 shows a plurality of selling investors SI and buying investors BI respective to each client-machine 54.

Selling investors SI₁₁ and SI₁₂ are customers of broker B1 that operates client-machine 54₁. Likewise buying investors BI₁₁ and BI₁₂ are also customers of broker B1 that operates client-machine 54₁. Selling investors SI₂₁ and SI₂₂ are customers of broker B2 that operates client-machine 54₂. Likewise buying investors BI₂₁ and BI₂₂ are also customers of broker B2 that operates client-machine 54₂. Selling investors SI₃₁ and SI₃₂ are customers of broker B3 that operates client-machine 54₃. Likewise buying investors BI₃₁ and BI₃₂ are also customers of broker B3 that operates client-machine 54₃. Selling investors SI₄₁ and SI₄₂ are customers of broker B4 that operates client-machine 54₄. Likewise buying investors BI₄₁ and BI₄₂ are also customers of broker B4 that operates client-machine 54₄.

Server 58 can be based on any type of computing environment suitable for performing server-type functions, such functions being more particularly described below, according to the scale and/or speed that is desired and/or number of client-machines, (such as client-machine 54), that are to be served by each. For example, server 58 can be a Sun 480R server from Sun Microsystems, Inc. of Palo Alto Calif., which has four central processing units (“CPUs”) and, because speed can be desired, such a server can be configured with about two to about five gigabytes (or more) of random access memory (“RAM”). Server 58 can be implemented as a plurality of servers working in conjunction with each other. However, it is to be emphasized that this particular model server is merely exemplary, a vast array of other types of computing environments, (either presently known or still as yet unconceived) are within the scope of the invention.

Whichever computing environment is chosen, server 58 is generally operable to act as a web-server that hosts an electronic municipal bond trading engine. (And thus it can be desired to implement the web-server functionality on one or more servers and the trading engine on another one or more servers.) Server 58 is typically owned and/or operated by a broker's brokerage firm. Those of skill in the art will now recognize that server 58 includes substantially the same functionality as any traditional, well-known, municipal bond trading engine that is currently known or as yet unconceived. An example of a known municipal bond trading system on which the engine can be based is the system operated by the broker's brokerage firm Chapdelaine & Co. and hosted at www.chappy.com, and is more particularly described in the U.S. patent application Ser. No. 10/346,222, filed Jan. 15, 2003 and entitled “Interactive Security Brokerage System”, incorporated herein by reference. However, as will be explained further below, server 58 is additionally configured to provide a novel and inventive trading interface.

Network 62 can be wired or wireless, or based on combinations thereof, and based on any type of known network architecture or platform or combinations thereof. Network 62 is typically, though need not be, the Internet. For example, in the alternative network 62 can be an intranet, a wide area network, a local area network or the like.

Likewise, the structure and implementation of the connections in system 50 are not particularly limited. (For example, client-machine 66 can be connected to server 58 via network 62 instead of via a direct connection.) Such connections include links with the double-headed arrows interconnecting client-machines 58 with network 62, and network 62 with server 58, and server 58 with client-machine 66. It is thus important to note that the geographic location of each component in FIG. 1 is not particularly limited, and that the connections between each of those components is chosen to reflect the nature of that link.

Client-machine 66 can be based on substantially the same computing components as client-machines 54. Client-machine 66 is operated by a broker's broker BB to interact with the trading engine hosted by server 58. Client-machine 66 can be used to permit broker's broker BB to intermediate, as needed, interactions between the various brokers operating client-machines 54. (While not shown, a plurality of client-machines 66 are typically connected to server 58, so that a plurality of broker's brokers employed by the broker's brokerage firm that owns/operates server 58 can assist brokers operating client-machines 54.)

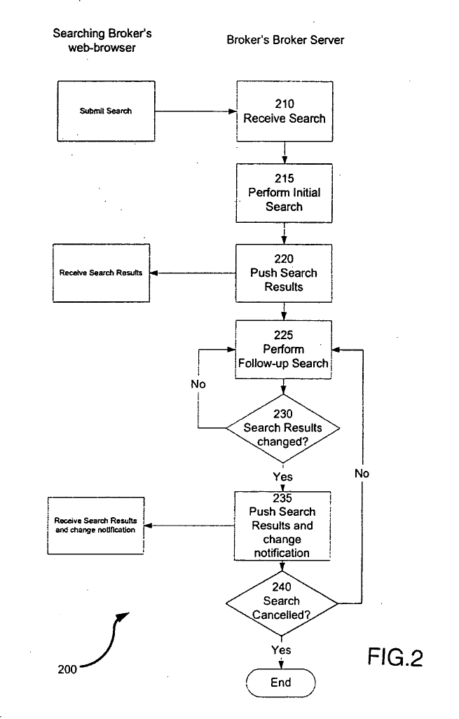

Referring now to FIG. 2, a flow-chart depicting a method 200 for controlling a computer interface in accordance with an embodiment of the invention is provided. In order to assist in the explanation of method 200, it will be assumed that it is performed using system 50. Furthermore, the following discussion of method 200 will lead to further understanding of system 50 and its various components. However, it is to be understood that system 50 and/or method 200 can be varied, and need not work exactly as discussed herein in conjunction with each other, and that such variations are within the scope of the present invention. For example, the order of performance of various steps can be varied, and certain steps can be omitted and/or additional steps added as desired.

Before explaining method 200, it will be assumed that brokers B operating client-machines 54 are all authenticated and logged-in to the municipal bond trading engine executing on server 58. It will also be assumed that a plurality of municipal bonds are being made available by selling investors SI on server 58. The manner in which these municipal bonds are being made available is not particularly limited, and are typically made available as offerings or bid-wanteds.

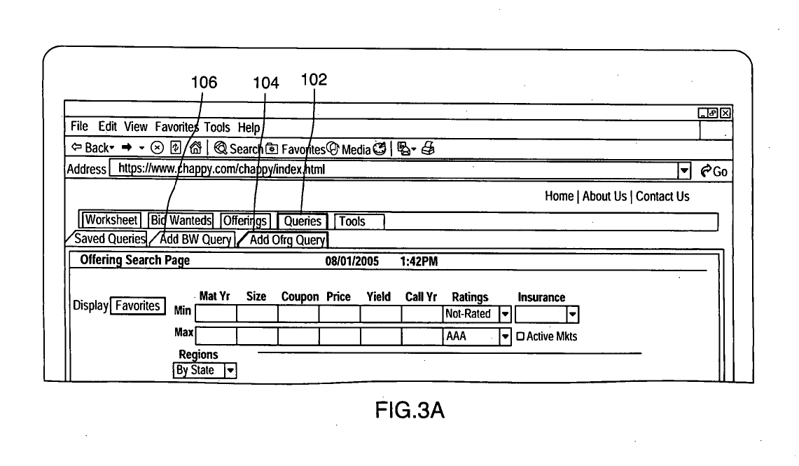

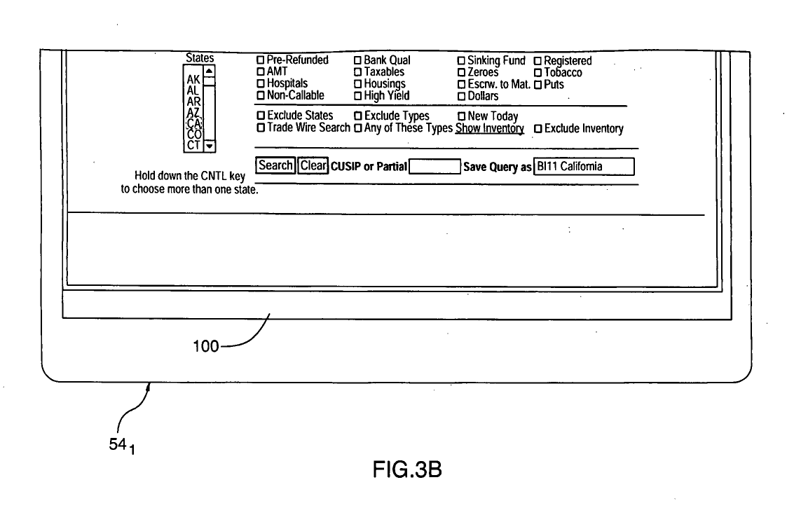

Beginning first at step 210, a search request is received at the broker's broker server. For example, in system 50 this step can be performed as broker B1 operating client-machine 54₁ is contacted by buying investor BI₁₁ who wants to know whether certain types of offerings are available, or will become available. Broker B1 can then call up a search request screen 100 as shown in FIG. 3. In the present example, search request screen 100 is accessed under a master-tab labelled Queries 102, and a sub-tab labelled Add Ofrg Query 104 (Short for “Add Offering Query”). (Thus this search is for offerings, but could also be for bid-wanteds under the sub-tab labelled Add BW Query 106 (Short for “Add Bid-Wanted Query”).

Search request screen 100 can use any desired criteria, and in a present example the search criteria includes searching by one or more states, and searching by whether or not the bond is or relates to: pre-refunded, bank qualified, subject to a sinking fund, registered, AMT (Alternative Minimum Tax. i.e. Whether interest on such bonds are subject to the AMT.), taxables (i.e. bonds that are fully subject to federal income tax in the same manner as corporate bonds), zeroes (i.e. bonds issued with no coupon value, pay no interest, and trade at a deep discount to PAR), tobacco, hospitals, housings, escrowed to maturity, puts, non-Callable, high yield, dollars. Other criteria include ratings, insurance, maturity year, size, coupon, price, yield, call year. The search can also be selected to exclude one or more of these. Persons skilled in the art will be able to examine FIG. 3 to ascertain the full range of search criteria that can be used in FIG. 3. However, it is to be understood that the type of search request is non-limiting.

In screen 100, a simple set of search criteria has been selected. A search for all California offerings has been selected. The search is named “BI11 California” in the “Save Query As” field so that the query can be used later. In this example, “BI11” is used to denote for broker B1 that the search is on behalf of buying investor BI₁₁ and “California” is used to denote the name of the search. Any naming convention can be used, however. Upon pointing-and-clicking upon the “Search” button in screen 100, the search criteria is sent to server 58, and once server 58 receives the search criteria in screen 100, step 210 is fulfilled.

At step 215, an initial search is performed. Step 215 is performed at server 58 based on the search criteria received at step 210. Step 215 is performed by the electronic municipal bond trading engine hosted by server 58 in the usual manner.

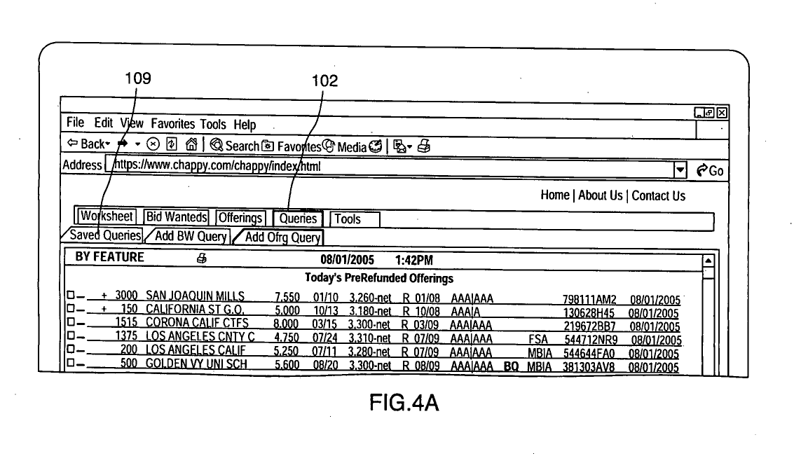

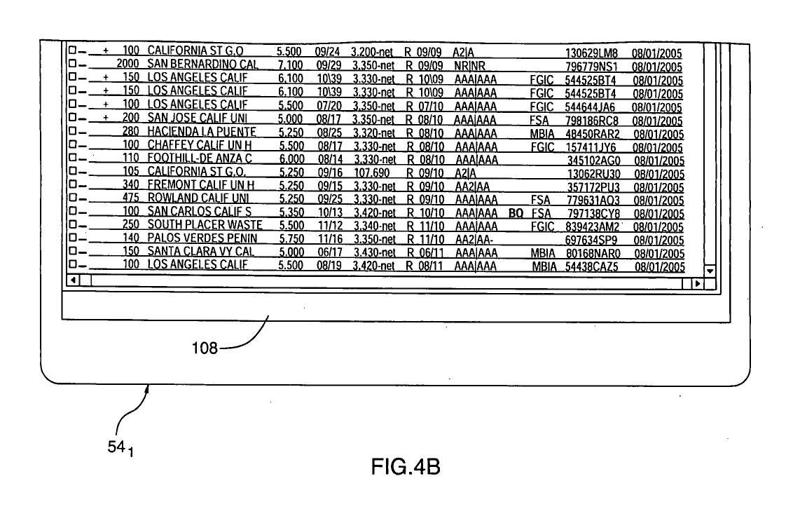

At step 220, the results of the search performed at step 215 are pushed back to the broker that submitted the request at step 210. In the example provided, performance of step 220 is represented in FIG. 4, as a search results screen 108 is presented on the display of client-machine 54₁ for viewing by broker B1.

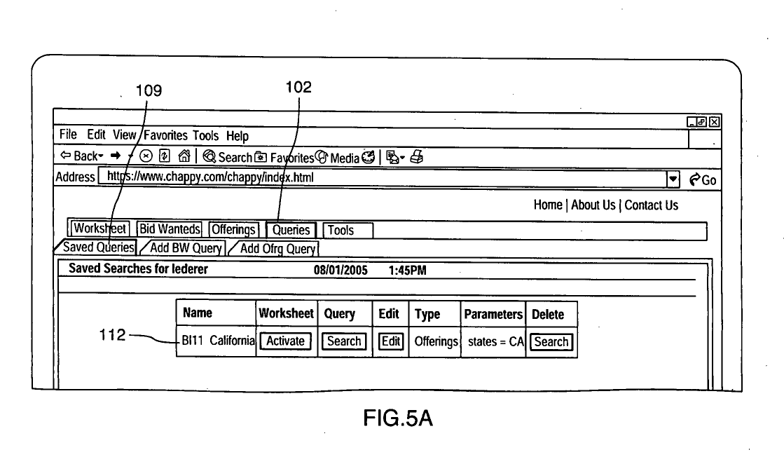

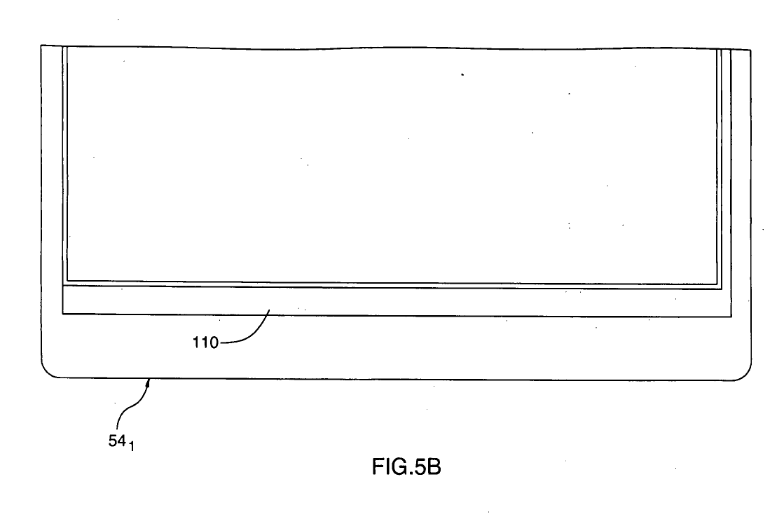

While not required in all embodiments, in a present embodiment broker B1 can then select the sub-tab labelled Saved Queries 109 on search results screen 108, in order to be presented with a saved queries screen 110 as shown in FIG. 5. Saved queries screen 110 shows a table, where each row in the table represents a previously created search as a result of performing step 210 or the like. The first entry 112 in saved queries screen 110 shows the particulars for the search criteria entered at screen 100, including the name of the search “BI11 California”. From saved queries screen 110, broker B1 can: i) activate the query so that it is automatically run under the master-tab worksheet 114 by selecting the button labelled “Activate”; ii) manually re-run the query by selecting the button labelled “Search”; iii) edit the query by selecting the button labelled “Edit”. (Such editing brings broker B1 back to screen 103 to change the terms of the search query.); iv) or delete the query by selecting the button labelled “Delete”). It is to be reemphasized that none of the foregoing is a requirement.

In the present example it is assumed that broker B1 selects the “Activate” button, on screen 110 thus leading to the performance of the remainder of method 200.

At step 225, a follow-up search is performed. Step 225 is performed by server 58 in substantially the same manner that step 215 was performed. Next, at step 230, a determination is made as to whether the search results have changed. The determination is based on whether the search results obtained at step 225 differ from the search results obtained the last time the search was performed. If, at step 230 it is determined that “no”, the search results have not changed then method 200 returns to step 225 to perform the follow-up search again. If, however, at step 230 it is determined that “yes”, the search results have changed, then method 200 advances to step 235.

At step 235, a notification that the search results have changed are pushed to client-machine 54₁ by server 58 so that broker B1 becomes immediately (or as immediately as possible) aware that the search results for the search entitled “BI11 California” have changed and are available for immediate review. Any type of indicia, visible, auditory, vibratory or combinations thereof to effect this notification can be used. The visible signal can include any type of visual notice on the screen, including, without limitation, a flashing dialogue box or an email. In a present embodiment the changed search results themselves are also pushed to client-machine 54₁, along with the notification, however, it is also contemplated in other embodiments that the changed search results can be pulled by broker B1 at client-machine 54₁ (once broker B1 has received the notification) from server 58 as desired. In other embodiments, the way in which the changed search results are pushed will serve as notification, in and of itself. For instance, automatically opening a tab, dialog box or window with the changed search results is also a form of notification. Step 235 (and further examples of notifications) will be discussed in further detail below.

At step 240, a determination is made as to whether the search is cancelled. A “yes” determination can be effected any number of ways, such as by broker B1 selecting the “Delete” button on screen 110 shown in FIG. 5. If a “yes” determination is made then method 200 terminates. If, however, a “no” determination is made then method 200 returns to step 225 and method 200 continues as previously described, looping from step 225 to step 240 until method 200 is terminated.

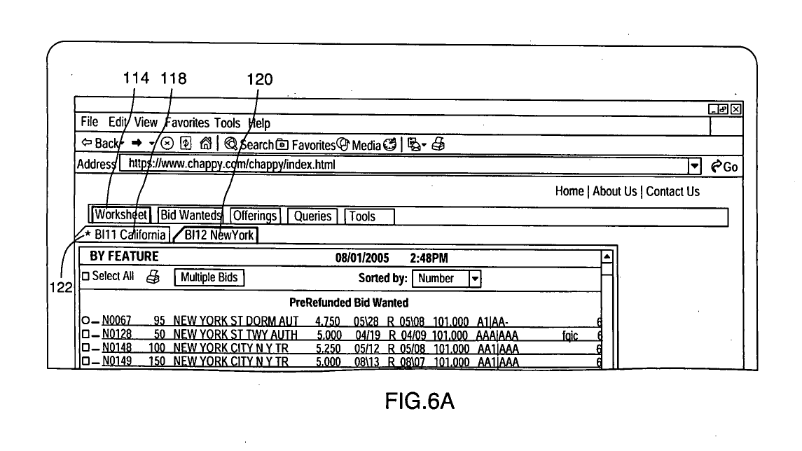

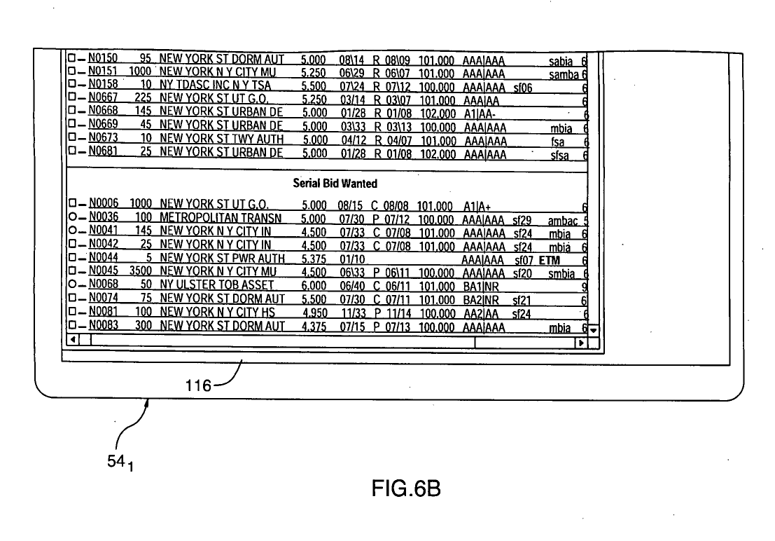

Recall that each broker B is typically acting simultaneously on behalf of a number of buying investors BI and selling investors SI. Thus, the foregoing example has been simplified for purposes of explanation, and only includes a single search. In practical application, it is contemplated that method 200 will be performed several times on behalf of each broker B, so that each broker B can maintain searches on behalf of a number of buying investors BI, and so that those brokers B can also receive automatic notifications of changes to such searches (eg. changes to the search results based on the same criteria) without having to manually refresh each search. (It is thus contemplated that the pushed search results in step 235 as displayed in screen 116 can be added to a worksheet for broker B1 and held as an active folder which will be continually refreshed by server 58 and a notification sent to client-machine 54₁ each time a new bond is found that meets the requirements of broker B1.) Continuing with the previous example, assume that buying investor BI₁₂ also contacts broker B1 and asks broker B1 to perform a search for all bid-wanteds available on New York state municipal bonds. Without disturbing the search entitled “BI11 California”, broker B1 can now perform method 200 for a new search entitled (for example) “BI12 New York”. Having now created two searches, broker B1 can then examine one search (or perform other tasks) without having to refresh the other search, knowing that if the results of the other search change broker B1 will be automatically notified of the change. This scenario is illustrated in FIG. 6, where broker B1 is showing viewing a worksheet screen 116, which is available under master-tab labelled Worksheet 114. Worksheet screen 116 includes two sub-tabs, one sub-tab for each search. The first sub-tab “BI11 California” 118 is respective to the first search performed using method 200; the second sub-tab “BI12 New York” 120 is respective to the second search performed using method 200. On screen 116, sub-tab “BI12 New York” 120 is in the foreground, and the results of that search are being displayed in screen 116. Sub-tab “BI11 California” 118 is in the background, and the search results are not being displayed. In this example, it is now assumed that the search results for “BI11 California” have changed during a respective, subsequent performance of method 200, and thus at step 235, a notification is also included on screen 116 that the search results for “BI11 California” have changed. In screen 116, the notification is implemented as an asterisk “*” labelled at reference 122 placed beside sub-tab 118. Asterisk 122 is used for illustrative purposes due to the limitation of patent drawings. Other types of notifications can include presenting a color representation of sub-tab “BI11 California” 118, and/or blinking the text on sub-tab “BI11 California” 118. Likewise, if broker B1 is not working on any sub-tab located under the tab labelled Worksheet 114, then the tab labelled Worksheet 114 can in and of itself change in color and thereby serve as the notification. In other words, the notification can be implemented in such a manner that regardless of what is being presented on the display of client-machine 54₁, some form of notification can be presented to indicate that the search results for “BI11 California” have changed. It should now be understood that visual notifications can take any form—e.g. the notification could be sent in an email and then the notification can take the form of a traditional email notification comprising a flashing-envelope icon located anywhere on the display of client-machine 54₁ so that the notification is visible regardless of the application currently being displayed on client-machine 54₁. As another example, the notification can simply be any type of icon presented anywhere on the display of client-machine 54₁ which is visible regardless of the application currently being displayed on client-machine 54₁, such that pointing-and-clicking on the icon opens screen 116 and thereby presents the information under sub-tab “BI11 California” 118. Audible notifications can also be used in addition to (or in lieu of) visual notifications.

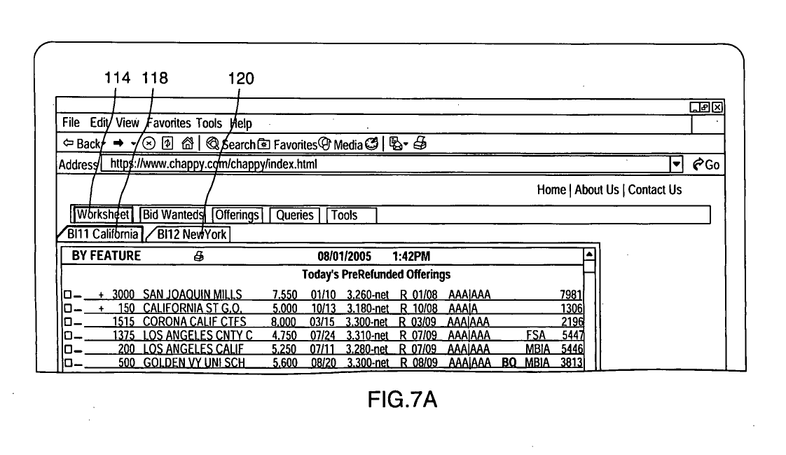

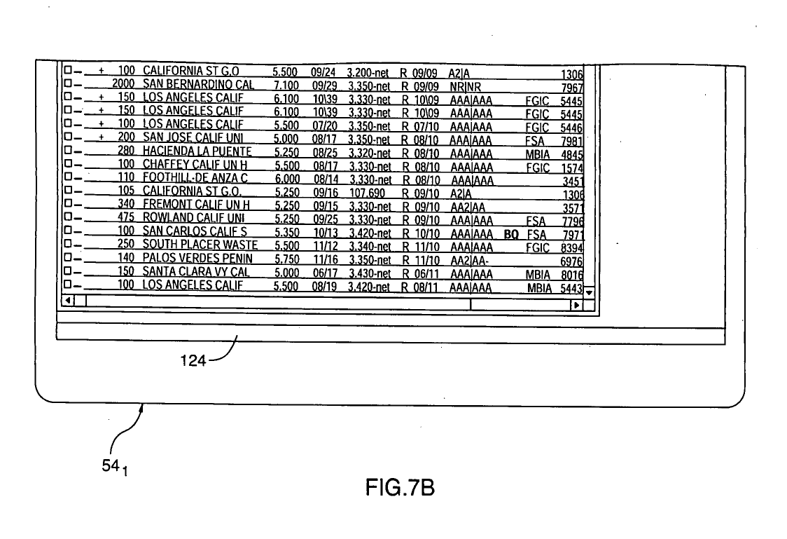

Thus, when, for example, broker B1 is viewing search results for “BI12 New York” on viewing screen 116, broker B1 will automatically be notified that changes have occurred to the search results for “BI11 California”. Broker B1 is thus able to concentrate on other tasks, confident that if changes to “BI11 California” arise, then broker B1 will automatically be notified. As represented in FIG. 7 on screen 124, broker B1 can then switch to view the new search results for “BI11 California” simply by selecting sub-tab 118, moving sub-tab “BI12 New York” 120 to the background, and hiding the results thereof. Likewise, sub-tab “BI11 California” 118 is then moved to the foreground, displaying the results thereof. Once sub-tab “BI11 California” 118 is in the foreground, then the notification is removed, thereby recognizing that broker B1 has acknowledged the notification and viewed the changed search results. In other words, the change notification presented at step 235 is turned-off once broker B1 provides an acknowledgement to server 58 that broker B1 has viewed the changed search results. At this point, broker B1 can now view the changed search results for “BI11 California”, also assured that if changes to “BI12 New York” occur then broker B1 will automatically be notified by way of an asterisk (or other suitable notification mechanism) placed on sub-tab 120 or other suitable means.

Utilizing the foregoing, a broker B can maintain and automatically monitor one or more searches for several buying investors B1. By automating monitoring municipal bond searches the broker B can operate more efficiently and/or more quickly and/or on behalf of more buying investors BI during a given trading session. The change notification presented at step 235 is typically turned-off once broker B1 provides an acknowledgement to server 58 that broker B1 has viewed the changed search results. Each search will continue, however, and broker B1 will be automatically notified of each change to the search, as long as the sub-tab 120 remains in the worksheet 114. This system efficiency allows a broker to address the needs of multiple buyers or sellers substantially simultaneously. This efficiency allows the broker's broker BB and each broker B1-B4 to bid multiple items for one customer, show offerings to another and revise an inquiry for a third customer in less time than it would take to do one of these searches using prior art systems. Those skilled in the art will also appreciate that during a given trading session a broker B may also act on behalf of one or more selling investors SI, in addition to acting on behalf of the buying investors BI, giving further efficiencies to each broker B.

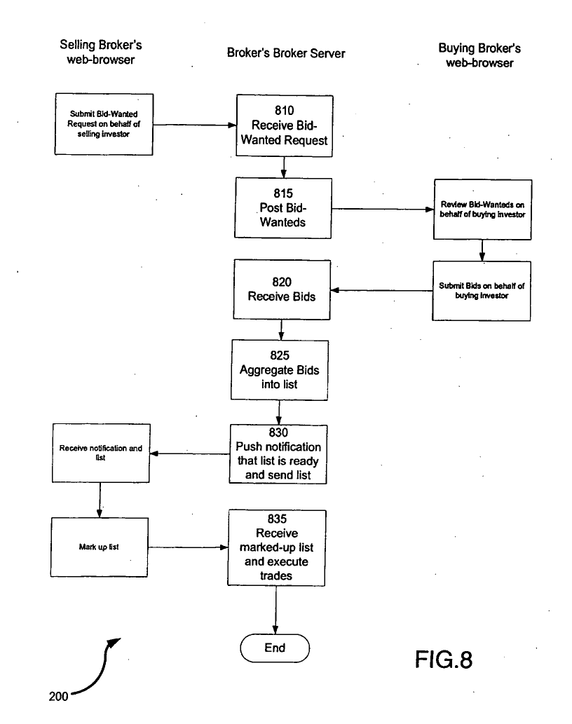

Method 200 thus also brings efficiencies and other advantages to broker B, as broker B can also concentrate on other tasks related to, for example, selling investors SI while being automatically notified of any changes to search results relating to buying investors BI that occur during the performance of those other tasks. Indeed one such selling investor task is also another embodiment, shown in FIG. 8. FIG. 8 shows a flow-chart depicting a method for controlling a computer interface in accordance with another embodiment of the invention, indicated generally at 800. Method 800 relates to a process whereby the broker's broker acts on behalf of a selling broker. The broker's broker posts a notice to potential buying brokers that bids are wanted (“bid-wanted”) for one or more municipal bonds. The broker's broker collects any bids that are received and aggregates the bids into a list for review by the selling broker.

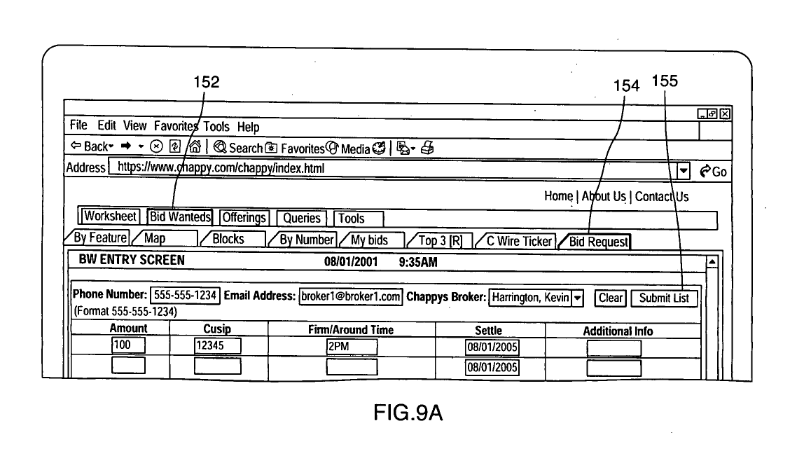

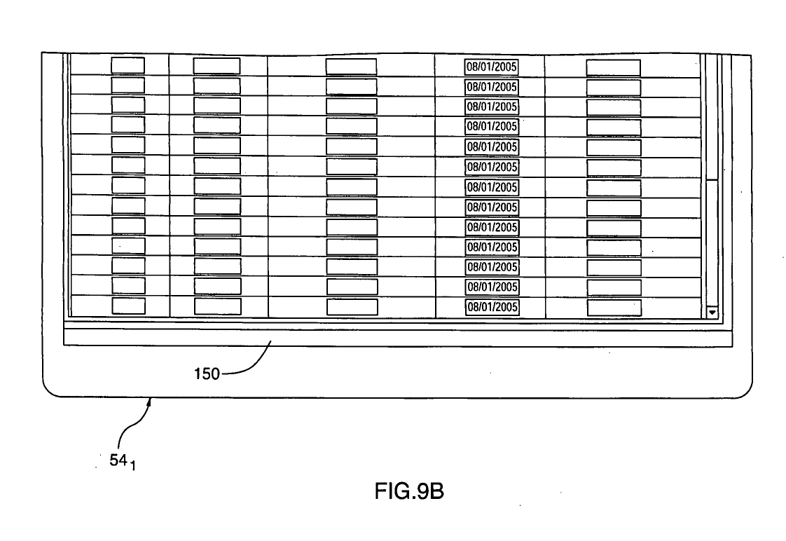

Beginning first at step 810, a bid-wanted request is received at the broker's broker server. For example, in system 50 this step can be performed as broker B1 operating client-machine 54₁ is contacted by selling investor SI₁₁ who wants to place a number of municipal bonds that are owned by selling investor SI₁₁ and for which selling investor SI₁₁ would like to sell by way of a bid-wanted process. Broker B1 can then call up a bid-request screen 150 as shown in FIG. 9. In the present example, bid request screen 150 is accessed under a master-tab labelled bid-wanteds 152, and a sub-tab labelled Bid Request 154.

Bid-request screen 150 includes a table with a number of fields. Each row in the table can be completed to identify one municipal bond that the selling investor SI₁₁ intends to place into a bid-wanted process. Fields shown on screen 150 include Amount, CUSIP, Firm/Around Time, Settle, Additional Info. The Amount field indicates the quantity of the particular municipal bond to be placed into the bid-wanted process. The CUSIP field identifies the CUSIP number for the municipal bond being placed into the bid-wanted process. “Firm/Around Time” identifies the time of day for submitting bids. If the time indicated in this field is a “Firm” time, which could be expressed, by way of example, as “2 FT 4”, in which case the selling investor SI is requested that bids be received by 2:00 PM and that those bids must be firm to the selling investor SI until 4:00 PM, and may not be pulled or cancelled by the bidder (e.g. the bidding buying investor BI) prior to 4:00 PM. If the time indicated is an “Around” time bid, then the bidder (e.g. the buying investor BI) may withdraw the bid at any time, provided the bonds are not in the process of actually being sold to that buying investor BI. “Settle” identifies any special terms of settlement that may accompany the municipal bond. In the absence of any special terms of settlement, the bid wanted will be processed for regular settlement in accordance with the practices for such regular settlement as understood by those skilled in the art. “Additional Information” includes any other particulars about the municipal bond that the broker may wish to include, although most relevant information can be automatically derived from the CUSIP Number.

In screen 150, an example has been placed in the first row of a municipal bond to be included in a bid-wanted process. The example includes an amount of 100, a CUSIP Number of 12345, a Firm/Around Time of 2:00 PM, and a settlement date of Aug. 4, 2005. No additional information is provided. (Those skilled in the art will realize that 12345 is an exemplary number and actual CUSIP numbers have nine alpha-numeric characters). According to this example selling investor SI₁₁ has submitted one-hundred municipal bonds bearing CUSIP 12345 to be included in a bid-wanted process for which any submitted bids will be considered at around 2:00 PM on the day the bid-wanted request is submitted, for a settlement date of Aug. 4, 2005. (Alternatively, the time could be indicated as, for example, “2-4”, will mean a request for bids that must be received by 2:00 PM and will be firm until 4:00 PM.) While only one municipal bond is being submitted in this bid-request example, it is contemplated that a plurality of municipal bonds are actually included. Also in screen 150, the telephone number and email address of broker B1 are included. Further, the broker's broker BB at the broker's brokerage firm operating server 58 is identified. Once screen 150 is complete, broker B1 can point and click on the “Submit List” button, indicated at 155, to actually send the list for viewing and processing by broker's broker BB at client-machine 66 via server 58. At this point the screen 150 is complete and has been submitted to the addressee broker's broker BB designated by broker B1. Broker's broker BB will then review the received bid-wanted request for errors and approve the items to be posted on server 58 and then profile the list of items to compile a list of top bids, using, for example, the “Top Three” process as described in U.S. patent application Ser. No. 10/346,222, filed Jan. 15, 2003 and entitled “Interactive Security Brokerage System”.

Next, at step 815, the bid-wanteds received at step 810 are posted. To effect step 815, broker's broker BB will provide instructions to server 58 via client-machine 66 to release the list so that other brokers B can search/browse those bid-wanteds, and place bids on behalf of any interested buying investors B1. For example, brokers B2, B3 and B4 can search and browse the bid-wanteds by performing method 200 (or simply steps 210-220). Assuming the correct search criteria are entered, the bid-wanteds received at step 810 will appear on a list of search results that are displayed to brokers. Such search results can be displayed in the substantially the same form as the search results shown on screen 116 of FIG. 6.

Brokers B2, B3 and B4 can thus decide to submit a bid on behalf of respective buying investors BI against the bid-wanteds posted at step 815. To the extent that any such bids are posted, they will thus be received at by server 58 at step 820.

At step 825, broker's broker BB will aggregate the bids received at step 820 by accessing the received bids now stored on server 58 via client-machine 66. Broker's broker BB will review and aggregate the bids for each municipal bond and compile a list of bids for review by broker B1, who submitted the bid wanted request at step 810. Broker's broker BB will typically ensure that each bid was properly made, that no errors were made when submitting the bid, and will compile a list of a top three (or less or more, as desired) bids that were received against a particular municipal bond.

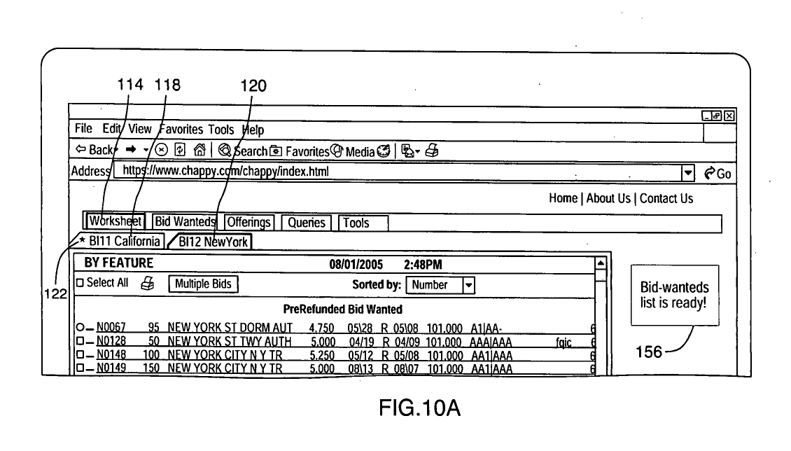

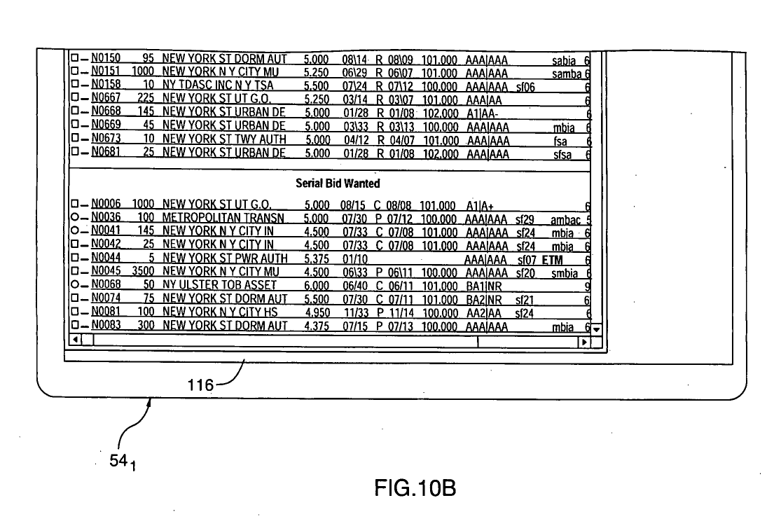

At step 830, a notification is pushed to client-machine 54₁ indicating that the list prepared at step 825 is complete. The notification can be effected in any desired manner, visual, auditory, vibratory or combinations thereof. In a present example, the notification is a dialogue box that is presented on the display of client-machine 54₁ which informs broker B1 that the list prepared at step 825 is complete. An exemplary format of such a dialogue box is shown in FIG. 10, and indicated at 156. FIG. 10 shows screen 116 from FIG. 6, except that in FIG. 10 screen 116 also includes dialogue box 156 which includes the message “Bid-wanteds list is ready”. Thus, broker B1 examining screen 116 can be examining search results of bid-wanteds for New York State on behalf of buying investor BI₁₂, while also being notified (via asterisk 122) that search results of offerings for California conducted on behalf of buying investor BI₁₁ have changed, while also being notified that a list of bids prepared in response to a bid-wanted process conducted on behalf of selling investor SI₁₁ is now ready for viewing. Thus, broker B1 can now, without making further inquiries of client-machine 54₁, prioritize whether to continue examining the search results of bid-wanteds for New York State, or switch to viewing the search results of offerings for California, or switch to examining the bids received in response to the bid-wanted process. Broker B1 can thus effectively and efficiently prioritize the needs of his/her buying investors BI and selling investors SI. The example in FIG. 10 demonstrates how both method 200 and method 800 can individually, and collectively, improve the efficiency of broker B1. By extension, efficiencies for all brokers B are improved via method 200 and method 800. Furthermore, efficiencies for broker's broker BB is also achieved using method 800, as broker's broker BB can avoid having to personally contact individual brokers B to indicate that lists of bids have been compiled and are ready for viewing.

While specific combinations of the various features and components of the present invention have been discussed herein, it will be apparent to those of skill in the art that desired subsets of the disclosed features and components and/or alternative combinations of these features and components can be utilized, as desired. For example, in a variant a broker as discussed in the embodiments herein can be substituted with other customers, including institutions, insurance companies, investment firms, hedge funds or individuals. As another example of, the embodiments can be varied so that system 50 provides direct access to the broker's broker from the selling investors and/or buying investors without the need for the intermediate broker B.

The contents of all documents referenced herein are incorporated herein by reference. The above-described embodiments of the invention are intended to be examples of the present invention and alterations and modifications may be effected thereto, by those of skill in the art, without departing from the scope of the invention which is defined solely by the claims appended hereto.

1. A method of controlling a computer interface for trading municipal bonds comprising:
receiving, at a municipal bond trading engine from a broker's client-machine connected to said trading engine, a plurality of search requests for available municipal bonds for purchase on behalf of one or more buying investors;
receiving, at said municipal bond trading engine from said broker's client-machine connected to said trading engine, a plurality of bid-wanted requests seeking bids for a plurality of municipal bonds for sale using a bid-wanted process on behalf of at least one selling investor;
performing and repeating, at said municipal bond trading engine, searches in accordance with said search requests;
pushing a search-update notification to said broker's client-machine each time a result of any one of said searches changes;
performing, at said municipal bond trading engine, a bid-wanted process in accordance with said bid-wanted request; said bid-wanted process including posting said bid-wanted, receiving bids responsive to said bid-wanted and aggregating said bids into a list; and,
pushing a bid-list ready notification to said broker's client-machine indicating that said list is ready for viewing by said broker.

2. The method of claim 1 further comprising the step of:
performing respective further follow-up searches and repeating the step of pushing a search-update notification to said broker's client-machine each time any one of said results changes until a command terminating one or more of said search requests is received from said broker's client-machine at said municipal bond trading engine.

3. The method of claim 1 wherein one or both of said notifications comprises at least one of an auditory, vibratory and a visual signal presented at said broker's client-machine.

4. The method of claim 1 further comprising the step of pushing results to said broker's client-machine.

5. The method of claim 1 further comprising the step of pushing results to said broker's client-machine based on input from said client-machine received at said trading engine requesting same.

6. The method of claim 1 further comprising presenting said search-update notification and said bid-list ready notification on said broker's client-machine at substantially the same time.

7. The method of claim 1 further comprising the step of pushing said list to said selling broker's client-machine.

8. The method of claim 1 wherein the broker is a dealer.

9. The method of claim 1 wherein the broker is a broker/dealer.

10. The method of claim 1 wherein the broker is a dealer/bank.

11. A municipal bond server for hosting trading municipal bonds by a broker's broker comprising:
an interface for connecting via a network to a first broker's client-machine and a plurality of additional broker's client-machines;
a processor interconnecting said interface via a bus with persistent storage and non-persistent storage; said processor configured to perform a plurality of programming instructions configuring said processor as a municipal bond trading engine; said trading engine operable to receive, via said interface, from said first broker's client-machine, a plurality of search requests for available municipal bonds for purchase on behalf of a plurality of buying investors;
said trading engine further operable to receive, via said interface, from said first broker's client-machine, a plurality of bid-wanted requests seeking bids for a plurality of municipal bonds for sale using a bid-wanted process on behalf of at least one selling investor;
said trading engine further operable to perform and repeat, searches in accordance with said search requests, and to push a search-update notification to said first broker's client-machine each time any one of said searches change;
said trading engine further operable to perform a bid-wanted process in accordance with said bid-wanted request; said bid-wanted process including posting said bid-wanted to at least some of said plurality of additional broker's client-machines, and receiving bids responsive to said bid-wanted and aggregating said bids into a list; and
said trading engine further operable to push a bid-list ready notification to said broker's client-machine indicating that said list is ready for viewing by said broker.

12. The server of claim 11 wherein said trading engine is further operable to perform respective further follow-up searches and repeat pushing a search-update notification to said broker's client-machine each time any one of said searches changes until a command terminating one or more of said search requests is received from said first broker's client-machine.

13. The server of claim 11 wherein one or both of said notifications comprises at least one of an auditory, vibratory and a visual signal presented at said broker's client-machine.

14. The server of claim 11 wherein said trading engine is further operable to push results of said searches to said first broker's client-machine.

15. The server of claim 12 wherein said trading engine is further operable to push results of said follow-up search to said broker's client-machine based on input from said client-machine received at said trading engine requesting same.

16. The server of claim 11 wherein said trading engine is further operable to present said search-update notification and said bid-list ready notification on said broker's client-machine at substantially the same time.

17. The server of claim 11 wherein said trading engine is further operable to push said list to said selling broker's client-machine.

18. A municipal bond broker's client-machine for use by a broker, said client-machine for interacting with a municipal bond server hosting trading of municipal bonds by a broker's broker comprising:
an interface for connecting via a network to said municipal bond server;
a processor interconnecting said interface via a bus with persistent storage, non-persistent storage, an input device and a display device; said processor configured to receive, via said input device, a search request for available municipal bonds for purchase on behalf of a buying investor; said processor operable to forward said search request to said municipal bond server via said interface;
said processor further operable to receive, via said input device, a plurality of bid-wanted requests seeking bids for a plurality of municipal bonds for sale using a bid-wanted process on behalf of at least one selling investor; said processor further operable to forward said bid-wanted requests to said municipal bond server;
said processor further operable to receive, via said interface, a search update-notification from said municipal bond server; said search-update notification representing that one or more searches performed in accordance with said search requests by said municipal bond server has changed; said processor further operable to present said search update-notification on said display device; and,
said processor further operable to receive, via said interface, a bid-list ready notification from said municipal bond server; said bid-list notification representing that a list of bids prepared according to said bid-wanted process is ready for viewing; said processor further operable to present said search bid-list notification on said display device.

19. The client-machine of claim 18 wherein the broker is a dealer.

20. The client-machine of claim 18 wherein the broker is a broker/dealer.

21. The client-machine of claim 18 wherein the broker is a dealer/bank.
